(19) United States
(12) Patent Application Publication
(10) Pub. No.: US 2015/0027111 A1
(43) Pub. Date: Jan. 29, 2015

(54) TURBINE SHELL DEFINING A SPRING RECEIVING POCKET

(71) Applicant: Schaeffler Technologies GmbH & Co. KG, Herzogenaurach (DE)

(72) Inventors: Markus Steinberger, Macedonia, OH (US); John Ramsey, Lucas, OH (US)

(21) Appl. No.: 14/337,087

(22) Filed: Jul. 21, 2014

Related U.S. Application Data
(60) Provisional application No. 61/858,320, filed on Jul. 25, 2013.

(51) Int. Cl. B23P 17/00; F16D 33/00

(52) U.S. Cl. CPC F16D 33/18; F16D 3/12
USPC 60/338; 29/888

(57) ABSTRACT

A torque converter is provided. The torque converter includes a plurality of arc springs and a turbine shell defining a pocket receiving the plurality of arc springs. The turbine shell may further include a rounded portion supporting turbine blades, an outer radial portion extending radially from the rounded portion and an axial extension extending axially from the outer radial portion. The rounded portion, the outer radial portion and the axial extension may define the pocket. A method for forming a drive assembly for a torque converter is also provided.

This claims the benefit to U.S. Provisional Patent Application No. 61/858,320, filed on Jul. 25, 2013, which is hereby incorporated by reference herein.

The present disclosure relates generally to torque converters and more specifically to retainers for springs of torque converters.

### BACKGROUND

U.S. Pat. No. 5,772,515 discloses springs being retainer by a piston rim.

U.S. Pat. No. 6,796,411 discloses a turbine shell with an integrated damper cover plate.

U.S. Publication No. 2007/0253823 discloses a spring retainer fixed to a turbine shell by folded blade tabs.

### SUMMARY OF THE INVENTION

A torque converter is provided. The torque converter includes a plurality of arc springs and a turbine shell defining a pocket receiving the plurality of arc springs.

Embodiments of the torque converter may also include one or more of the following advantageous features:

The turbine shell may include a rounded portion supporting turbine blades, an outer radial portion extending radially from the rounded portion and an axial extension extending axially from the outer radial portion. The rounded portion, the outer radial portion and the axial extension may define the pocket. A first side of the outer radial portion faces the arc springs and a second side of the outer radial portion includes a friction surface. The drive assembly may further include an impeller and the turbine shell may be axially movable toward and away from the impeller. The turbine shell may include a friction surface for engaging an engagement surface of the impeller. The friction surface and the engagement surface may form a lockup clutch. The drive assembly may further include a drive segment fixed to the turbine shell. The drive segment may include rounded portions circumferentially spaced between the arc springs. The drive segment may include radial extending portions circumferentially between the rounded portions of the drive segment axially offset from the rounded portions of the drive segment. The turbine shell may include an outer radial portion and the arc springs may be axially between the radial extending portions of the drive segment and the outer radial portion of the turbine shell. The drive assembly may further include a drive component circumferentially drivable by the arc springs having tabs extending between the radial extending portions of the drive segment and between the arc springs. The drive assembly may further include a guide shell supporting the arc springs. The turbine shell may include a rounded portion and an axial extension coupled to the rounded portion of the turbine shell. The guide shell may contact the axial extension of the turbine shell. The guide shell may extend along less than half of the circumference of the arc springs. The rounded portion of the turbine shell may contact the arc springs on an opposite side of where the guide shell contacts the arc springs. The drive assembly may further include a drive segment drivingly engaging the arc springs and holding the guide shell in place.

A method for forming a torque converter is also provided. The method may include retaining arc springs in a pocket defined by a turbine shell.

Embodiments of the method may also include one or more of the following advantageous features:

The method may also include forming the turbine shell to include a rounded portion supporting turbine blades, an outer radial portion extending radially from the rounded portion and an axial extension extending axially from the outer radial portion. The rounded portion, the outer radial portion and the axial extension of the turbine shell may define the pocket. The retaining the arc springs in the pocket defined by the turbine shell may include holding the arc springs circumferentially against the rounded portion of the turbine shell. The method may further comprise providing a guide shell at a radial inner surface of the axial extension of the turbine shell. The guide shell may hold the arc springs against the rounded portion of the turbine shell. The method may further include hardening the guide shell before providing the guide shell at the radial inner surface of the axial extension of the turbine shell. The method may further include fixing a drive segment to the turbine shell. The drive segment may drivingly engage the arc springs in the pocket. The method may further include forming the drive segment from a sheet such that the drive segment includes a first portion for driving engaging the arc springs in the pocket and a second portion for holding a guide shell contacting the outer circumference of the arc springs in the pocket.

### BRIEF DESCRIPTION OF THE DRAWINGS

The present invention is described below by reference to the following drawings, in which:

FIG. 1 shows a cross-sectional view of a torque converter in accordance with an embodiment of the present invention;

FIGS. 2a and 2b show plan view of a drive segment of the torque converter in accordance with two embodiments of the present invention; and

FIG. 3 shows a cross-sectional view of a portion of a torque converter in accordance with another embodiment of the present invention.

### DETAILED DESCRIPTION

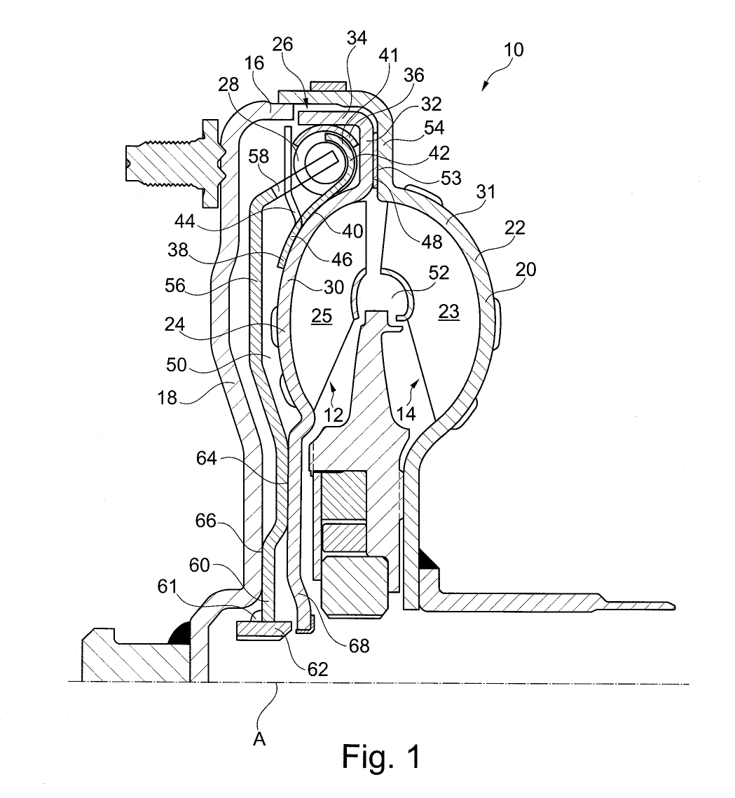

FIG. 1 shows a cross-sectional view of torque converter 10 in accordance with an embodiment of the present invention. Torque converter 10 includes a turbine 12 that is axially movable toward and away from an impeller 14 to engage and disengage turbine 12 from impeller 14 and cover 16 of torque converter 10. Cover 16 includes a front portion 18 for connecting to a crankshaft of an internal combustion engine and a rear portion 20 forming a shell 22 of impeller 14. Front portion 18 and rear portion 20 are both substantially cup shaped and are joined by providing an axial extension of front portion 18 radially inside of an axial extension of rear portion 20 and then welding the axial extensions together.

Turbine 12 includes a turbine shell 24 defining a pocket 26 receiving a plurality of arc springs 28. In this embodiment, pocket 26 is formed by a rounded portion 30 of turbine shell 24, an outer radial portion 32 extending radially outward from rounded portion 30 and an axial extension 34 extending axially from outer radial portion 32, such that pocket 26 surrounds arc springs 28 on three sides thereof. Arc springs 28 held in pocket 26 by a guide shell 36, a drive segment 38 and an outer surface 40 of rounded portion 30 of turbine shell 24.

In one embodiment, guide shell 36 may be formed as a continuous ring extending around axis A that has an arc shaped cross section, has an inner radial surface that extends along less than half of an outer circumference of arc springs 28 and outer radial surface that contacts an inner radial surface of axial extension 34. In another embodiment, instead of being a continuous ring, guide shell 36 may be formed by a plurality of segments having arc shaped cross sections, each positioned at one of arc springs 28.

Drive segment 38 includes a first portion formed as drive tabs 41 including rounded portions 42 circumferentially spaced between arc springs 28 for circumferentially driving arc springs 28 and includes a second portion formed by radial extending portions 44 circumferentially between and axially offset from rounded portions 42 and acting as retention tabs holding guide shell 36 in place in pocket 26. Arc springs 28 are axially between radial extending portions 44 of drive segment 38 and outer radial portion 32 of turbine shell 24. In one embodiment, drive segment 38 is a continuous ring formed from a single sheet of metal. In other embodiments, instead of being a continuous ring, drive segment 38 may be formed by a plurality of segments.

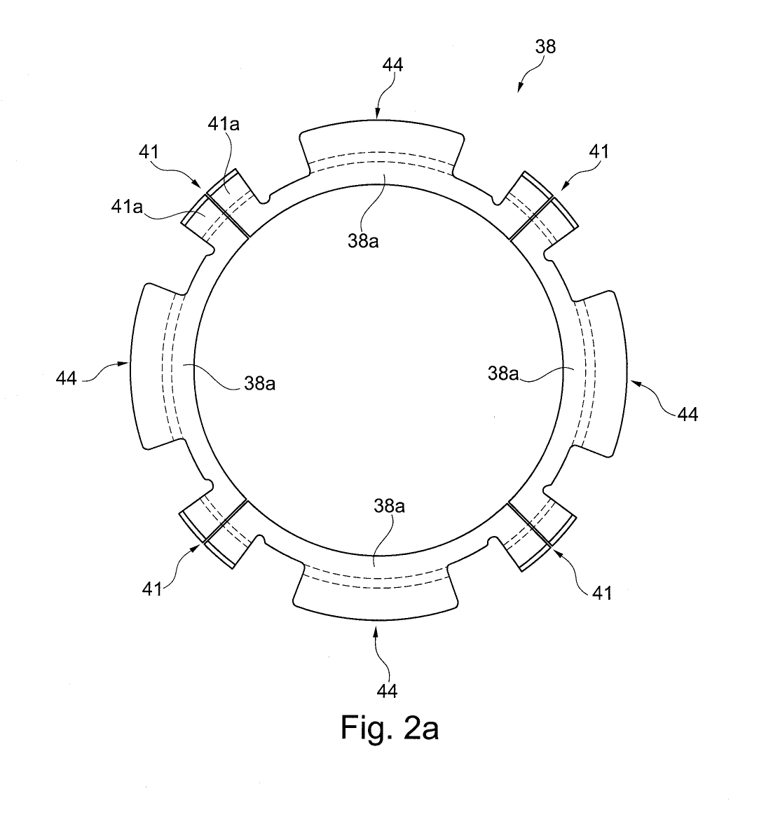

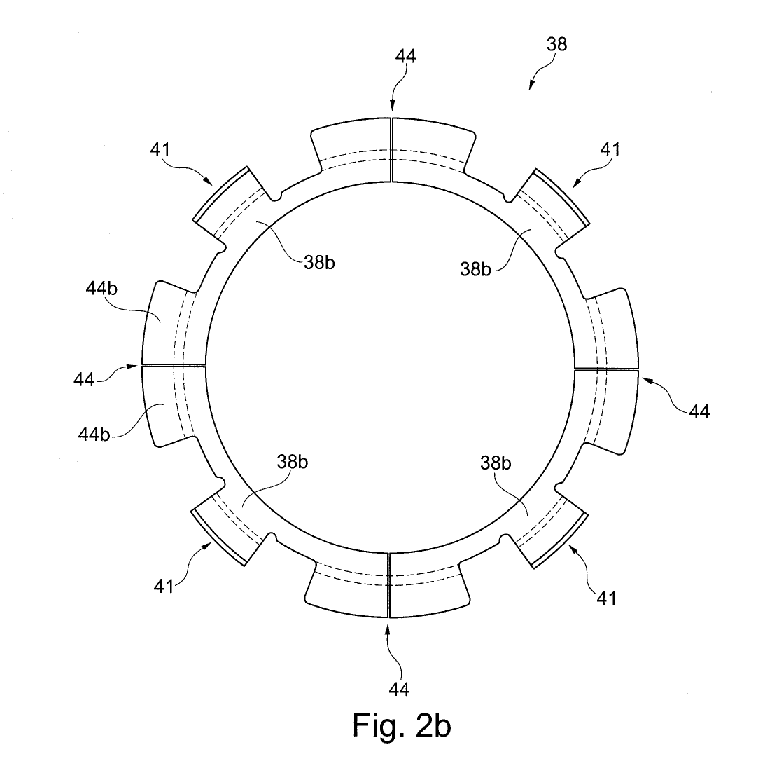

FIG. 2a shows a plan view of drive segment 38 formed by four segments 38a. Each segment 38a is arc shaped as viewed in a plan view in FIG. 2a (i.e., viewed axially in FIG. 1) and includes one radial extending portion 44 between two drive tab halves 41a. Each drive tab half 41a is positioned at a circumferential end of segment 38a and forms a drive tab 41 with a tab half 41 a of the adjacent circumferential end of the adjacent segment 38a. Arc springs 28 are received circumferentially between adjacent drive tabs 41, with the drive segment 38 shown in FIG. 2a driving (via tabs 41) and retaining (via radial extending portions 44) four arc springs 28. Tabs 58 of drive plate 56, which are discussed further below, circumferentially align with drive tabs 41 of segments 38a.

FIG. 2b shows a plan view of drive segment 38 formed by four segments 38b. Each segment 38b is arc shaped as viewed in a plan view in FIG. 2b (i.e., viewed axially in FIG. 1) and includes one drive tab 41 between two radial extending portion halves 44b. Each radial extending portion half 44b is positioned at a circumferential end of segment 38b and forms a radial extending portion 44 with a radial extending portion half 44b of the adjacent circumferential end of the adjacent segment 38b. Arc springs 28 are received circumferentially between adjacent drive tabs 41, with the drive segment 38 shown in FIG. 2b driving (via tabs 41) and retaining (via radial extending portions 44) four arc springs 28. Tabs 58 of drive plate 56 circumferentially align with drive tabs 41 of segments 38b.

Referring back to FIG. 1, a base portion 46 of drive segment 38, which rounded portions 42 and radial extending portions 44 protrude from in a Y-shape when viewed cross-sectionally, is fixed to outer surface 40 of turbine shell 30 by projection welding, for example, so that torque is transferred from turbine 12 to arc springs 28 via drive segment 38, in particular via rounded portions 42.

A friction surface is formed on a surface of outer radial portion 32 facing away from pocket 26 by a friction material layer 48. When a force generated by fluid pressure in a fluid pressure region 50 between turbine 12 and front cover portion 18 overcomes a force generated by fluid pressure in a fluid pressure region 52 between turbine 12 and impeller 14, turbine 12 is pressed axially toward impeller 14 so that friction material 48 engages an engagement surface 53 of an outer radial portion 54 of impeller 14, which extends radially outward from a rounded portion 31 of impeller shell 22, and turbine 12 and impeller 14 are locked together by a lockup clutch formed by friction material 48 and engagement surface 53, causing turbine 12 to rotate with impeller 14 and cover 16 at the same rotational velocity about axis A. When a force generated by fluid pressure in fluid pressure region 50 does not overcome a force generated by fluid pressure in fluid pressure region 52 between turbine 12 and impeller 14, friction material 48 does not engage engagement surface 53 of impeller 14 and turbine 12 may rotate at a different rotational velocity than impeller 14 and cover 16 about axis A. When turbine 12 and impeller 14 are not locked together by the lockup clutch, turbine 12 is rotated by a fluid flow between turbine blades 25 supported on rounded portion 30 of turbine shell 24 and impeller blades 23 supported on rounded portion 31 of impeller shell 22.

As turbine 12 is driven by impeller 14, either through contact via friction material 48 and impeller shell 22 or through fluid flow between blades 23, 25, turbine 12 transfers torque from drive segment 38 to arc springs 28, which circumferentially drive a drive component formed as a drive plate 56. Drive plate 56 then transfers the torque to a shaft for driving a downstream drive component, for example a variable-speed transmission. A radial outer end of drive plate 56 forms a spring receiver formed by tabs 58 circumferentially spaced from each other that mesh with springs 28 by extending axially into spaces circumferentially between springs 28 such that drive plate 56 is circumferentially drivingly engaged with springs 28. Tabs 58 also extend axially through circumferential spaces between radial extending portions 44 of drive segment 38, which are circumferentially spaced far enough apart from each other to allow tabs 58 to drive arc springs 28 to full windup in drive and coast directions. Drive plate 56 also includes a radial inner end 60 that is connected to a connector 62 by a weld 61. Connector 62 has a splined inner surface for connecting to a splined outer surface of the shaft for driving the downstream drive component. Drive plate 56 includes a first thrust surface 64 that may contact an inner radial extension 68 of turbine shell 24, which extends radially inward from rounded portion 30, when friction material 48 is not in frictional engagement with outer radial portion 54 of impeller 14. Drive plate 56 also includes a second thrust surface 66 that may contact an inner surface of front portion 18 of cover 16. To limit or prevent wear of thrust surfaces 64, 66, these portions of drive plate 56 are modified to have a low coefficient of friction, which provides for smooth interactions between thrust surfaces 64, 66 and the inner surface of front portion 18 and inner radial extension 68. For example, thrust surfaces 64, 66 may be formed by a Teflon coating, a layer of low friction material, a plastic washer or a bearing.

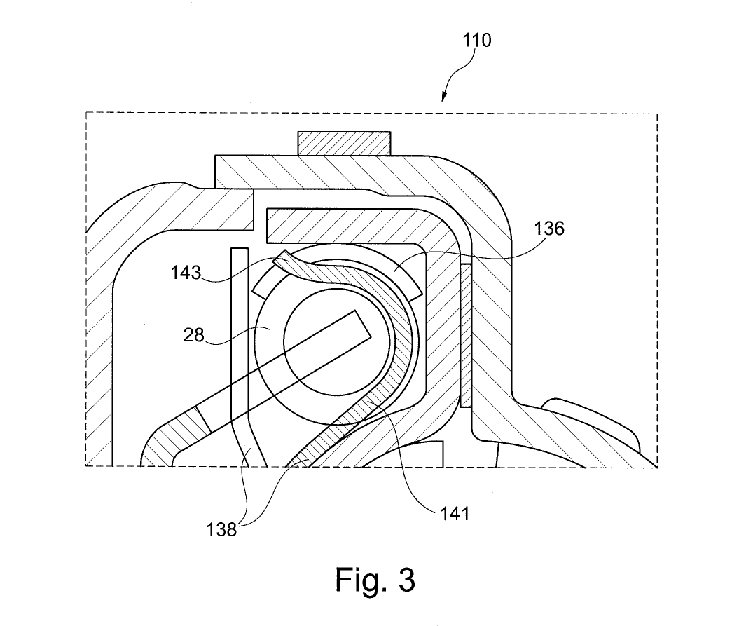

FIG. 3 shows a cross-sectional view of a portion of torque converter 110 in accordance with another embodiment of the present invention. Torque converter 110 is substantially the same as torque converter 10 shown in FIG. 1, except drive segment 38 is replaced by a drive segment 138 including drive tabs 141 each having a radially extending portion or distal end 143 for circumferential positioning of a segment guide shell 136. Guide shell 136 is formed by a plurality of segments having arc shaped cross sections, each positioned at one of arc springs 28. For each drive tab 141, distal end 143 extends radially outward in between two adjacent segments of guide shell 136 so as to contact a circumferential end of each guide shell segment and retain the guide shell segments circumferentially with respect to axis A.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A drive assembly for a torque converter comprising:
a plurality of arc springs; and
a turbine shell defining a pocket receiving the plurality of arc springs.

2. The drive assembly as recited in claim 1 wherein the turbine shell includes a rounded portion supporting turbine blades, an outer radial portion extending radially from the rounded portion and an axial extension extending axially from the outer radial portion, the rounded portion, the outer radial portion and the axial extension defining the pocket.

3. The drive assembly as recited in claim 2 wherein a first side of the outer radial portion faces the arc springs and a second side of the outer radial portion includes a friction surface.

4. The drive assembly as recited in claim 1 further comprising an impeller, the turbine shell being axially movable toward and away from the impeller.

5. The drive assembly as recited in claim 4 wherein the turbine shell includes a friction surface for engaging an engagement surface of the impeller, the friction surface and the engagement surface forming a lockup clutch.

6. The drive assembly as recited in claim 1 further comprising a drive segment fixed to the turbine shell, the drive segment including rounded portions circumferentially spaced between the arc springs.

7. The drive assembly as recited in claim 6 wherein the drive segment includes radial extending portions circumferentially between the rounded portions of the drive segment axially offset from the rounded portions of the drive segment.

8. The drive assembly as recited in claim 7 wherein the turbine shell includes an outer radial portion, the arc springs being axially between the radial extending portions of the drive segment and the outer radial portion of the turbine shell.

9. The drive assembly as recited in claim 7 further comprising a drive component circumferentially drivable by the arc springs having tabs extending between the radial extending portions of the drive segment and between the arc springs.

10. The drive assembly as recited in claim 1 further comprising a guide shell supporting the arc springs, the turbine shell including a rounded portion and an axial extension coupled to the rounded portion, the guide shell contacting the axial extension of the turbine shell.

11. The drive assembly as recited in claim 10 wherein the guide shell extends along less than half of the circumference of the arc springs.

12. The drive assembly as recited in claim 11 wherein the rounded portion of the turbine shell contacts the arc springs on an opposite side of where the guide shell contacts the arc springs.

13. The drive assembly as recited in claim 10 further comprising a drive segment drivingly engaging the arc springs and holding the guide shell in place.

14. A method for forming a drive assembly for a torque converter comprising:
retaining arc springs in a pocket defined by a turbine shell.

15. The method as recited in claim 14 further comprising forming the turbine shell to include a rounded portion supporting turbine blades, an outer radial portion extending radially from the rounded portion and an axial extension extending axially from the outer radial portion, the rounded portion, the outer radial portion and the axial extension defining the pocket.

16. The method as recited in claim 15 wherein the retaining the arc springs in the pocket defined by the turbine shell includes holding the arc springs circumferentially against the rounded portion of the turbine shell.

17. The method as recited in claim 16 further comprising providing a guide shell at a radial inner surface of the axial extension of the turbine shell, the guide shell holding the arc springs against the rounded portion of the turbine shell.

18. The method as recited in claim 17 further comprising hardening the guide shell before providing the guide shell at the radial inner surface of the axial extension of the turbine shell.

19. The method as recited in claim 14 further comprising fixing a drive segment to the turbine shell, the drive segment drivingly engaging the arc springs in the pocket.

20. The method as recited in claim 19 further comprising forming the drive segment from a sheet such that the drive segment includes a first portion for driving engaging the arc springs in the pocket and a second portion for holding a guide shell contacting the outer circumference of the arc springs in the pocket.
